(19) United States
(12) Patent Application Publication
(10) Pub. No.: US 2006/0286250 A1
(43) Pub. Date: Dec. 21, 2006

(54) Method for stabilizing a food product, a stabilizer-emulsifier blend and use thereof

(76) Inventors: Stig Groven, Horsens (DK); Jacob Ailko DeVries, Brabrand (DK)

Correspondence Address: FROMMER LAWRENCE & HAUG, 745 FIFTH AVENUE- 10TH FL., NEW YORK, NY, 10151, US

(21) Appl. No.: 11/440,991

(22) Filed: May 25, 2006

Related U.S. Application Data
(63) Continuation-in-part of application No. PCT/EP04/13440, filed on Nov. 26, 2004.

(30) Foreign Application Priority Data
Nov. 28, 2003 (FI) 20031751

(51) Int. Cl. A23L 1/05

(52) U.S. Cl. 426/573

(57) ABSTRACT

The invention relates to a method for stabilizing a food product by adding to fat containing food ingredients a cold dispersible emulsifier and a hydrocolloid stabilizer for providing a cold-prepared heat stable fat emulsion, with the proviso that when the emulsifier is sodium stearoyl-2-lactylate (SSL), the stabilizer is not carrageenan iota. The invention also relates to a blend of a cold-soluble hydrocolloid stabilizer and a cold dispersible emulsifier capable of improving the stability of cold-prepared emulsified food products and to the use thereof as well as to an emulsified meat product which is cold-prepared and heat stabilized by a blend according to the invention.

The present invention relates to a method for stabilizing a meat product, to a cold prepared heat-stable emulsion, as well as to a stabilizer-emulsifier blend and use thereof.

### BACKGROUND

Thickeners and gelling agents are well-known ingredients in the meat industry. Carrageenans and starches are widely used to bind water in injected meat products like ham as well as in diminished meat products like sausages. In addition, hydrocolloids like gelatine are used in meat related products like aspic, coatings and the like.

The main emulsifiers used in meat products are sodium caseinates. Also soy protein may have emulsifying properties. Low molecular weight emulsifiers are less frequently used in meat products. The main use of sodium caseinate and soy protein is in cold prepared high fat “emulsions”, e.g. from lard. However, sodium caseinate and soy protein are expensive ingredients and the use of them raises the costs of the end products.

In the meat industry emulsions are intermediate products that are included in the final sausage and other types of emulsified meat product recipes. Therefore, they should be able to undergo further processing like forming, smoking and heating. One important requirement for an emulsion in the meat industry is that it should be heat stable. Meat emulsions are not necessarily emulsions in the scientific sense of the word. They are more like a system of finely divided fat or oil in a continuous water phase, or finely divided water in a continuous fat phase. Meat emulsions should therefore be seen as macroscopically homogenous fat/water systems.

Although there is a substantial amount of literature on the effect of stabilizers and low molecular weight emulsifiers on emulsions in general, this has not resulted in any extensive use of such combinations in meat products. Starch/emulsifier interactions have been studied intensively, but still this has not resulted in the application of their interaction effects in meat products.

Patent publication WO 03/075682 relates to a food additive comprising carrageenan iota and SSL (sodium stearoyl-2-lactylate). The food additive, which has emulsifying and/or stabilising properties, can be used in the food industry and in the production of food products. The food additive can replace caseinate and soy protein and it is said to-be cost effective.

However, there are no other possible alternatives suggested for the carrageenan iota and SSL in the WO publication, although they are not necessarily suitable for every desired emulsion. Thus, there is need to find alternative food additives which can be used in cold-prepared, and at the same time also heat stable fat emulsions.

The present inventors have surprisingly found that not only the combination of carrageenan iota and SSL, but also other combinations of emulsifiers and stabilizers can be used in cold prepared heat stable fat emulsions or can be applied directly in emulsified meat products provided that the emulsifier is a cold dispersible emulsifier and the stabilizer is a hydrocolloid. This was unexpected since the properties of different stabilizers and different emulsifiers are very diverse from each other and it was not, based on the prior art, possible to predict the functionality of specific combinations.

### SUMMARY OF THE INVENTION

The present invention relates to a method for stabilizing a meat product wherein a cold dispersible emulsifier and a hydrocolloid stabilizer are added to fat containing food ingredients for providing a cold-prepared heat stable fat emulsion, with the proviso that when the emulsifier is sodium stearoyl-2-lactylate (SSL), the stabilizer is not carrageenan iota.

The stabilizer used in the method according the present invention is preferably a cold-soluble hydrocolloid compound. The preferred stabilizer is selected from the group consisting of alginate, xanthan, guar, pectin, carboxy methyl cellulose, carrageenan, starch, LBG (Locust Bean Gum) and combinations thereof.

An emulsifier used in the method according to the present invention is a cold dispersible emulsifier which is suitable for use in the food industry. The preferred emulsifier is selected from the group consisting of stearate, poly sorbate, SSL, an ester of citric acid, an ester of succinic acid, an ester of diacetyl tartaric acid or an ester of poly glycerol, and combinations thereof.

A preferred emulsifier is provided by stearate or SSL. A preferred stabilizer in combination with the above emulsifier comprises alginate and/or xanthan. The stabilizer of the invention is preferably provided in combination with starch.

An especially preferred combination used in the method according to the present invention is where the emulsifier is stearate and the stabilizer comprises alginate or xanthan. An excellent combination is provided by alginate and stearate.

In the method according to the present invention the emulsifier and the stabilizer are preferably provided in a powder blend which can be dissolved in water. The resulting solution can then be used to malce a pre-emulsion with fat, e.g. lard. Alternatively, the solution can be added directly to the meat food formulation. It is, however, also possible to add the emulsifier and stabilizer, preferably as a powder blend, directly to the meat product formulation, in which case the components will dissolve in water existing in the formulation.

In the present invention meat refers to the flesh of any animal or animals, including but without limiting, pork, bovine, fowl and fish.

In the present invention a meat product refers to any processed (e.g., heated, injected, diminished, camied and/or cured) meat product or meat analogue. A meat analogue is a product having an appearance similar to a meat product but being based on vegetable or microbial raw material, typically soy or wheat. Examples of meat analogs are vegetable pates and soy-based sausages. The meat product is preferably a sausage, a luncheon meat, a pate or an other emulsified meat product.

In the present invention a cold prepared heat-stable fat emulsion refers to a fat/water dispersion prepared without heating and remaining stable when heated afterwards.

In a preferred method according to the present invention the stabilizer and the emulsifier are added in a ratio between 1:10 and 20:1.

The present invention also relates to the use of a blend of a cold-soluble hydrocolloid stabilizer and a cold dispersible emulsifier for improving the stability of cold-prepared meat products.

In a use according to the present invention the emulsifier is preferably selected from the group consisting of stearate, poly sorbate, SSL, an ester of citric acid, an ester of succinic acid, an ester of diacetyl tartaric acid or an ester of poly glycerol, and combinations thereof, with the proviso that when the emulsifier is sodium stearoyl-2-lactylate (SSL), the stabilizer is not caltageenan iota.

A preferred stabilizer in the use according to the present invention is selected from the group consisting of alginate, xanthan, guar, pectin, carboxy methyl cellulose, carrageenan, starch, LBG and combinations thereof.

In the use according to the present invention stearate and SSL are preferred as said emulsifier and alginate and xanthan are preferred for use as said hydrocolloid stabilizer to provide heat stability to a meat product, preferably a sausage or other emulsified meat product.

The present invention relates also to a blend of a cold-soluble hydrocolloid stabilizer and a cold dispersible emulsifier capable of improving the stability of cold-prepared meat products. The emulsifiers and stabilizers preferred in the blend are those mentioned above.

The present invention also relates to a meat product which is cold-prepared and heat stabilized by a blend according to the present invention. The meat product is preferably a sausage or a luncheon meat. The present invention provides special benefits in food products which undergo heat treatment prior to consumption.

### DETAILED DESCRIPTION OF THE INVENTION

In the present invention fat (e.g. lard) and other ingredients needed for the meat product are mixed and the cold dispersible emulsifier and hydrocolloid stabilizer are added to the mixture. The emulsifier and stabilizer are preferably premixed in dry or semidry powder form to provide a blend. The blend is preferably dissolved in water to provide a solution which is then added to the food ingredients. The solution may be mixed with the fat (e.g. lard) or oil to provide a pre-emulsion which is then combined with the other ingredients. Alternatively, the solution is mixed directly with the food ingredients to provide the desired emulsion. The emulsifier and stabilizer may also be added directly to the meat ingredients. In this case it is really preferred to mix the emulsifier and stabilizer into a blend before addition to the food ingredients to ensure uniform distribution of the components in the aqueous phase of the meat product.

The blend of the emulsifier and the stabilizer and the meat ingredients is cold prepared in order to preserve the raw materials. At the final production step the meat product is generally heated, wherefore it is important that the fat emulsion is heat stable. Mixing and emulsifying are performed in a conventional way used in the industry and no special equipment is required. The lard emulsions are usually prepared by diminishing lard in a water/ice mixture with high speed rotating knives.

The blend of the emulsifier and the stabilizer together provide a texture which is stable also when the fat emulsion is heated. This has not been achieved properly in the prior art with the ingredients used previously in cold prepared meat products. Another advantage of the method according to the present invention is that food products prepared by the method also have good firmness. The present invention enables the preparation of good quality final products in a cost effective way.

The meat product of the present invention is any processed (heated, injected, diminished, canned, cured) meat product containing fat and other ingredients which need to be emulsified. In a preferred embodiment the emulsion is also heat stable. Such meat products are different kinds of sausages and emulsified meat, such as luncheon meat. The various meat products are prepared in conventional ways even when a method according to the present invention is used.

The emulsions of the present invention are macroscopically homogenous fat/water systems wherein the finely divided fat or oil is in a continuous water phase, or finely divided water is in a continuous fat phase. Thus, the emulsions of the present invention are not actually emulsions in the strict meaning of the word. The preferred emulsions prepared according to the present method are also heat stable, i.e. their texture and composition is not affected by heating. Therefore, they are easily further processed e.g. by forming, smoking and heating depending on the desired final product.

Emulsifiers are molecules which have both a hydrophobic end and a hydrophilic end enabling mixing of lipids and water into an emulsion that does not separate. Emulsifiers can also improve the distribution of oil and fat. Conventional emulsifiers are produced from vegetable oils, animal fat and glycerol. The emulsifiers of the present invention are cold dispersible and they are preferably sodium stearoyl-2-lactylate (SSL), stearate, poly sorbate, an ester of citric acid, an ester of succinic acid, an ester of diacetyl tartaric acid and/or an ester of poly glycerol. The preferred stearates used in the present invention are alkali or alkali earth metal stearate, such as sodium stearate, calcium stearate or potassium stearate. An ester of citric acid used in the present invention is e.g. citric acid esters of monoglycerides (such as CITREM). An ester of diacetyl tartaric acid used in the invention is e.g. diacetyl tartaric acid esters of monoglycerides (such as DATEM).

The stabilizers used in the present invention are hydrocolloid stabilizers. Stabilizers are special ingredients used in emulsions with or without emulsifiers in order to make the emulsion stable. Stabilizers ensure homogenous distribution and consistency of the emulsion. Stabilizers prevent e.g. sedimentation of the ingredients in the mixture and malce sure that the mixture remains even.

The hydrocolloid stabilizers that perform well in the present invention are cold-gelling or cold-soluble. The preferred procedure whereby first a dispersion of the emulsifier/hydrocolloid blend in water is made allows the hydrocolloids to be dissolved in the absence of gelling ions that are provided by the other ingredients used in the food product.

Preferred stabilizers of the present invention are alginate, xanthan, guar, pectin, carboxy methyl cellulose, carrageenan, starch. Also LBG can be used in the present invention.

Alginates are linear unbranched polymers naturally found in brown seaweeds (Phaeophyceae, mainly Laminaria). Alginates are not random copolymers but, according to the source algae, consist of blocks of similar and strictly alternative residues each of which have differed conformational preferences and behaviour. They may be prepared with a wide range of average molecular weights (50-100000 residues) to suit the application.

Xanthan is an exocellular polysaccharide produced by fermentation of the bacteria Xanthomonay campestris, originally isolated from the rutabaga plant. It is a cream-coloured powder that is dissolved in water to produce a thick viscous solution at low concentrations. Xanthan remains stable over a wide temperature range and forms a strong fine on drying.

Guar is a galactomannan similar to locust bean gum consisting of a (1-4)-linked b-D-mannopyranose backbone with branch points from their 6-positions linked to a-D-galactose (i.e. 1-6-linked-a-D-galactopyranose). There are between 1.5-2 mannose residues for every galactose residue.

Alginate gels are very heat-stable which explains why alginate gives the hardest final products. Alginate is therefore the most preferred hydrocolloid of this invention. Also xanthan provides an especially good stabilizer for the present invention. The carrageenan used in the present invention can be any kind of carrageenan, such as iota, kappa, sodium and/or calcium carrageenan. The starch used in the invention can be native and/or modified starch such as instant starch. Starch is a hydrocolloid but starch alone is not sufficient as the hydrocolloid stabilizer in most preparations. However, it plays a supportive role and allows for reduction of the amount of the other hydrocolloids used.

When Ca-sensitive hydrocolloids like alginate and carrageenan are used, Ca-salts and/or sequestrants may optionally be added to improve dissolution of the hydrocolloid and to control the rate of calcium dissolution. Examples of suitable Ca-salts are CaSO₄, CaHPO₄, CaCl₂, Ca-lactate, Ca-citrate and Ca-gluconate. Examples of suitable sequestrants are Na-phosphates, Na-pyrophosphates and Na-polyphosphates.

Both an emulsifier and a stabilizer are needed for the preparation of a heat stable fat emulsion according to the invention. Stabilizers alone can give good cold-prepared emulsions, but only combinations with a cold dispersible emulsifier result in heat-stable products. Not all stabilizers and emulsifiers work in combination to provide a desired stabilizing effect. It was known that SSL and carrageenan iota provide an effective combination. However, the present inventors have surprisingly found that there are also other advantageous combinations of emulsifiers and stabilizers. Some of these combinations are even more efficient than the combination of SSL and carrageenan iota. This is especially true when the stabilizer is alginate and/or xanthan and the emulsifier is stearate.

Fats are fatty acid esters of glycerol. The hardness of the fats depends on the degree of unsaturation of the fatty acids. A high degree of unsaturation causes softness of the fat. Animal fats have a high content of saturated fatty acids and they are mostly solid at room temperature. The fat used in the present invention depends on the food product to be prepared. In some formulations of the present invention the fat is not solid at room temperature.

The other raw materials of the food products are chosen depending on the desired product.

The stabilizers and emulsifiers are used in proportions which are necessary in the product in question in order to provide cold prepared heat stable meat product. The stabilizer and emulsifier are preferably added in a ratio between 1:10 and 20:1.

The stabilizer and emulsifier are preferably made into a premixed blend and dissolved in water before mixing with the other ingredients. A preferred blend, which has proven very efficient in practice, contains 5 to 30% SSL or stearate, 5 to 30% alginate and/or xanthan and 90 to 40% starch calculated on the dry substance. An especially preferred blend contains 15 to 30% stearate, 4 to 10% alginate or 5 to 15% xanthan and 81 to 40% starch calculated on the dry substance. The starch is preferably used in a combination of native and modified starch.

Optionally the blend contains also Ca-salts and/or sequestrants. Preferable Ca-salts are CaSO₄, CaHPO₄, CaCl₂, Ca-lactate, Ca-citrate and Ca-gluconate. Generally the blend contains 0-20% Ca-salt, preferably 2-10%. Preferable sequestrants are Na-phosphates, Na-pyrophosphates and Na-polyphosphates. Generally the blend contains 0-20% sequestrant, preferably 1-10%.

The actual amount of Ca-salt and sequestrant to be added depends on the nature of the stabilizer and the environment provided by the other ingredients in the emulsion. These salts are used to control the properties lile dispersebility, solubility and gelation of the stabilizer.

The invention is illustrated below with a few examples.

### EXAMPLE 1

The effectiveness of the invention was tested in lard emulsions. First a blend was prepared by suspending the hydrocolloid and the emulsifier in water to provide a blend at 5% concentration. Then 1 part of the blend, 8 parts of water/ice, 8 parts of pork back fat cut into cm squares were mixed in a bowl chopper. The mixtures were then heated in glass jars for 1 hour at 80° C. water bath. 17 different kinds of blends were tested. Those included prior art emulsions based on SSL and carrageenan iota as well as emulsions based on sodium caseinate and soy protein.

| Sample | Hydrocolloid / emulsifier blend |
|---|---|
| 1 | 10% iota-carrageenan, 20% SSL, 70% starch (Prior art) |
| 2 | 10% iota-carrageenan, 20% Na-stearate, 70% starch |
| 3 | 10% alginate, 20% SSL, 70% starch |
| 4 | 15% xanthan, 20% SSL, 65% starch |
| 5 | 100% Na-caseinate (Prior art) |
| 6 | 100% Soy protein (Prior art) |
| 7 | 10% iota-carrageenan, 20% NaCl, 70% starch |
| 8 | 10% iota-carrageenan, 20% Citrem N-12, 70% starch |
| 9 | 10% iota-carrageenan, 20% Panodan 81, 70% starch |
| 10 | 10% iota-carrageenan, 20% sucrose ester S1670, 70% starch |
| 11 | 20% SSL, 70% starch, 10% NaCl |
| 12 | 10% iota-carrageenan, 20% polysorbate 80, 70% starch |
| 13 | 10% iota-carrageenan, 20% hexaglycerol mono-di palmitate, |
| | 70% starch |
| 14 | 10% alginate 20% Na-stearate, 70% starch |
| 15 | 15% xanthan 20% stearate 65% starch |
| 16 | 10% alginate, 20% SSL, 63% starch, 5% CaSO4, |
| | 2% Na-pyrophosphate |
| 17 | 10% alginate, 20% SSL, 65% starch, 5% CaSO4 |

The ingredients used were the following:
iota-carrageenan: Benvisco SI-100 (Shemberg)
alginate: alginate FD175 (Danisco)
xanthan: Keltrol (CP Kelco)
starch: potato starch (Avebe)
instant starch: Instant Cleariel (National Starch)
caseinate: EM-7 (DMV, Holland)
soy protein: Supro 500E (DuPont)
sugar ester Ryoto S-1670 (Mitsubishi)
polysorbate 80: (Sigma)
hexaglycerol mono di palmitate (Danisco experimental sample)
SSL: SSL-P55 (Danisco)
Citrem N-12 citric acid ester (Danisco)
Panodan 81: DATEM ester (Danisco)
Na-stearate: (Sigma)

The starch used was a combination of 80% potato starch and 20% instant or waxy starch.

The visual appearance of the emulsions was evaluated visually before and after heating.

| | Visual appearance | Visual appearance |
|---|---|---|
| Sample | before heating | after heating |
| 1 | Stable | Stable |
| 2 | Stable | Stable |
| 3 | Stable | Stable |
| 4 | Stable | Stable |
| 5 | Stable | Stable |
| 6 | Stable | Almost stable |
| 7 | Stable, somewhat coarse | Phase separated |
| 8 | Stable | Almost stable |
| 9 | Stable | Almost stable |
| 10 | Unstable | Unstable |
| 11 | Unstable | Unstable |
| 12 | Stable | Almost stable |
| 13 | Stable | Almost stable |
| 14 | Stable | Stable |
| 15 | Stable | Stable |
| 16 | Stable | Stable |
| 17 | Stable | Stable |

Confocal laser light microscopy with fat staining of emulsion nr. 1 showed that the fat was not present as small droplets, but as larger irregularly shaped particles. Nevertheless, the product was macroscopically homogenous.

All the hydrocolloid stabilizers that performed well were cold-gelling or cold-soluble. The alginate and xanthan emulsions were also heat-stable. The results indicated that both a cold dispersible emulsifier and a hydrocolloid stabilizer were needed for preparation of a heat-stable emulsion. Hydrocolloid stabilizers alone can give good cold-prepared emulsions, but only the combinations with an emulsifier resulted in heat stable products. Starch alone was not sufficient as a stabilizer, but it played a supportive role and allowed for reduction of the amount of the other hydrocolloid stabilizers used.

### EXAMPLE 2

Fat emulsions nr. 1, 2, 3 and 4 prepared in Example 1 were tested in a luncheon meat type sausage recipe, which had the following ingredients.

| | |
|---|---|
| Water / ice | 29.0% |
| Phosphate | 0.4% |
| Non fat meat | 20.0% |
| Fat emulsion 1, 2, 3 or 4 | 16.0% |
| Sodium nitrite | 0.015% |
| Dextrose | 0.3% |
| Salt | 2% |
| Potato starch | 2% |
| Ascorbic acid | 0.05% |
| Flavour / spices | 0.5% |
| Lard | 29.7% |

Meat, fat emulsion, salt, phosphate, nitrite and 60% of the water were chopped up to 6-8° C. The fat, dextrose, spices and the rest of the water was added and chopped up until 11-12° C. Finally the starch was added and mixing was stopped after 15 seconds. Vacuum was applied (65 mmHg) for 1 minute and the product was stuffed in non-permeable casing and cooked for 1 hour at 80° C.

The sausages were evaluated by SMS (Stable Micro Systems) equipment: TA-TX, test made is gel breaking test and visually.

| | SMS breaking strength | |
|---|---|---|
| | (Force in g/cm² | |
| Sample | at 6 mm penetration) | Visual inspection |
| Nr 1 | 550 | Homogenous* |
| Nr 2 | 540 | Homogenous with some white specks |
| Nr 3 | 610 | Homogenous |
| Nr 4 | 470 | Homogenous |

*with meat pieces evenly distributed.

All the sausages prepared were firm and visually homogenous (meaning no water and fat separation). The sausage containing alginate was the firmest one.

### EXAMPLE 3

The present invention was also tested in spreadable liver sausages and compared to a prior art combination of Citrem and soy protein.

Spreadable liver sausages were prepared using as ingredients pork liver, belly strip, smoked streaky bacon, NaCl, seasoning and water or soup.

Emulsification and stabilization was provided by: GRINDSTED® CITREM N 12 VEG Citric Acid Ester or a blend of alginate/Na-stearate or a blend of xanthan/Na-stearate, respectively, added at a level of 1 to 2% of the blend based on the total weight of the ingredients.

The alginate/stearate was tested in the range 4-10%/15-30% in the blend and the xanthan/stearate was tested in the range 5-15%/15-30% in the blend.

The emulsifying blends of the invention as well as the Citrem were dissolved in water prior to the mixing with the other ingredients. The liver was ground through a 3 mm holed plate and the emulsifying components were added. The mixture was mixed with water and the other ingredients in the conventional manner to provide a sausage which was filled into sterile casings and cooked at 85° C. to an internal temperature of 75° C.

The alginate/stearate combinations were found to result in a liver sausage having the best stability. The liver sausage was firmer than that produced with Citrem and soy protein and also firmer than a liver sausage produced under similar conditions using SSL and carrageenan iota.

The xanthan/stearate combinations were found to give stable emulsions which had a firmness comparable to the ones provided by Citrem and soy protein.

The liver sausages produced according to the invention with combinations of alginate or xanthan and stearate were also evaluated sensorically and they were found to have a good taste. At a stearate level of 22% one out of four evaluators noted a slight off taste in the product.

The present invention has been illustrated in detail by the above examples. It is evident to those skilled in the art that the invention may be used in many different ways and many different applications.

The invention will now be further described by the following numbered paragraphs:
2. A method for stabilizing a meat product comprising adding to fat containing food ingredients a cold dispersible emulsifier and a hydrocolloid stabilizer for providing a cold-prepared heat stable fat emulsion, with the proviso that when the emulsifier is sodium stearoyl-2-lactylate (SSL), the stabilizer is not carrageenan iota.
2. The method according to paragraph 1, wherein said stabilizer is a cold-soluble compound selected from the group consisting of alginate, xanthan, guar pectin, carboxy methyl cellulose, carrageenan, starch, locust bean gum and combinations thereof.
3. The method according to paragraph 1, wherein said emulsifier is selected from the group consisting of stearate, poly sorbate, SSL, an ester of citric acid, an ester of succinic acid, an ester of diacetyl tartaric acid or an ester of poly glycerol, and combinations thereof.
4. The method according to paragraph 3 wherein said emulsifier is stearate or SSL.
5. The method according to paragraph 4 wherein said stabilizer comprises alginate, xanthan or carrageenan.
6. The method according to paragraph 5, wherein said stabilizer is provided in combination with starch.
7. The method according to paragraph 1, wherein said emulsifier is SSL and the hydrocolloid stabilizer comprises alginate and/or xanthan.
8. The method according to paragraph 1, wherein said emulsifier is stearate and said hydrocolloid stabilizer comprises alginate and/or xanthan.
9. The method according to paragraph 7 or 8, wherein said alginate or xanthan is combined with starch.
10. The method according to paragraph 9, wherein said compounds are provided in a premixed blend in water containing 5 to 30% SSL or stearate, 5 to 30% alginate and/or xanthan and 90 to 40% starch calculated on the dry substance.
11. The method according to paragraph 9, wherein said compounds are provided in a blend containing 15 to 30% stearate, 4 to 10% alginate or 5 to 15% xanthan and 81 to 40% starch calculated on the dry substance.
12. The method according to paragraph 9, wherein said starch is a combination of native and modified starch.
13. The method according to paragraph 1, wherein said meat product is a sausage or other emulsified meat product.
14. The method according to paragraph 1, wherein said meat product is a product which is heat treated prior to consumption.
15. The method according to any one of the preceding paragraphs, wherein the stabilizer and emulsifier are added in a ratio between 1:10 and 20:1.
16. The use of a blend of a cold-soluble hydrocolloid stabilizer and a cold dispersible emulsifier for improving the stability of a cold-prepared meat product.
17. The use of a blend of a cold-soluble hydrocolloid stabilizer and a cold dispersible emulsifier for manufacturing a cold-prepared heat stable fat emulsion.
18. The use according to paragraph 16 or 17, wherein said emulsifier is selected from the group consisting of stearate, poly sorbate, SSL, an ester of citric acid, an ester of succinic acid, an ester of diacetyl tartaric acid or an ester of poly glycerol, and combinations thereof, with the proviso that when the emulsifier is sodium stearoyl-2-lactylate (SSL), the stabilizer is not carrageenan iota.
19. The use according to paragraph 18, wherein said stabilizer is selected from the group consisting of alginate, xanthan, guar, pectin, carboxy methyl cellulose, carrageenan, starch, locust bean gum and combinations thereof.
20. The use according to paragraph 19, wherein alginate is used as said hydrocolloid stabilizer to provide heat stability to a meat product, preferably a sausage or other emulsified meat product.
21. A blend of a cold-soluble hydrocolloid stabilizer and a cold dispersible emulsifier capable of improving the stability of cold-prepared emulsified meat products.
22. The blend according to paragraph 21, wherein said emulsifier is selected from the group consisting of stearate, poly sorbate, SSL, an ester of citric acid, an ester of succinic acid, an ester of diacetyl tartaric acid or an ester of poly glycerol, and combinations thereof, with the proviso that when the emulsifier is sodium stearoyl-2-lactylate (SSL), the stabilizer is not carrageenan iota.
23. The blend according to paragraph 22, wherein said emulsifier is stearate or SSL.
24. The blend according to paragraph 21, wherein said stabilizer is selected from the group consisting of alginate, xanthan, guar, pectin, carboxy methyl cellulose, carrageenan, starch, locust bean gum and combinations thereof, with the proviso that when the stabilizer is carrageenan iota, the emulsifier is not SSL.
25. The blend according to paragraph 24, wherein said stabilizer is a combination of alginate and/or xanthan and starch.
26. An emulsified meat product which is cold-prepared and heat stabilized by a blend according to any one of paragraphs 21 to 25.
27. The meat product according to paragraph 26, which is a sausage or a luncheon meat.

1. A method for stabilizing a meat product comprising adding to fat containing food ingredients a cold dispersible emulsifier and a hydrocolloid stabilizer for providing a cold-prepared heat stable fat emulsion, with the proviso that when the emulsifier is sodium stearoyl-2-lactylate (SSL), the stabilizer is not carrageenan iota.

2. The method according to claim 1, wherein said stabilizer is a cold-soluble compound selected from the group consisting of alginate, xanthan, guar pectin, carboxy methyl cellulose, carrageenan, starch, locust bean gum and combinations thereof.

3. The method according to claim 1, wherein said emulsifier is selected from the group consisting of stearate, poly sorbate, SSL, an ester of citric acid, an ester of succinic acid, an ester of diacetyl tartaric acid or an ester of poly glycerol, and combinations thereof.

4. The method according to claim 3 wherein said emulsifier is stearate or SSL.

5. The method according to claim 4 wherein said stabilizer comprises alginate, xanthan or carrageenan.

6. The method according to claim 5, wherein said stabilizer is provided in combination with starch.

7. The method according to claim 1, wherein said emulsifier is SSL or stearate and the hydrocolloid stabilizer comprises alginate and/or xanthan.

8. The method according to claim 7, wherein said alginate or xanthan is combined with starch.

9. The method according to claim 8, wherein said compounds are provided in a premixed blend in water containing 5 to 30% SSL or stearate, 5 to 30% alginate and/or xanthan and 90 to 40% starch calculated on the dry substance.

10. The method according to claim 8, wherein said compounds are provided in a blend containing 15 to 30% stearate, 4 to 10% alginate or 5 to 15% xanthan and 81 to 40% starch calculated on the dry substance.

11. The method according to claim 8, wherein said starch is a combination of native and modified starch.

12. The method according to claim 1, wherein said meat product is a sausage or other emulsified meat product.

13. The method according to claim 1, wherein said meat product is a product which is heat treated prior to consumption.

14. The method according to claim 1, wherein the stabilizer and emulsifier are added in a ratio between 1:10 and 20:1.

15. The use of a blend of a cold-soluble hydrocolloid stabilizer and a cold dispersible emulsifier for improving the stability of a cold-prepared meat product or for manufacturing a cold-prepared heat stable fat emulsion

16. The use according to claim 15, wherein said emulsifier is selected from the group consisting of stearate, poly sorbate, SSL, an ester of citric acid, an ester of succinic acid, an ester of diacetyl tartaric acid or an ester of poly glycerol, and combinations thereof, with the proviso that when the emulsifier is sodium stearoyl-2-lactylate (SSL), the stabilizer is not carrageenan iota.

17. The use according to claim 16, wherein said stabilizer is selected from the group consisting of alginate, xanthan, guar, pectin, carboxy methyl cellulose, carrageenan, starch, locust bean gum and combinations thereof.

18. The use according to claim 17, wherein alginate is used as said hydrocolloid stabilizer to provide heat stability to a meat product, preferably a sausage or other emulsified meat product.

19. A blend of a cold-soluble hydrocolloid stabilizer and a cold dispersible emulsifier capable of improving the stability of cold-prepared emulsified meat products.

20. The blend according to claim 19, wherein said emulsifier is selected from the group consisting of stearate, poly sorbate, SSL, an ester of citric acid, an ester of succinic acid, an ester of diacetyl tartaric acid or an ester of poly glycerol, and combinations thereof, with the proviso that when the emulsifier is sodium stearoyl-2-lactylate (SSL), the stabilizer is not carrageenan iota.

21. The blend according to claim 20, wherein said emulsifier is stearate or SSL.

22. The blend according to claim 19, wherein said stabilizer is selected from the group consisting of alginate, xanthan, guar, pectin, carboxy methyl cellulose, carrageenan, starch, locust bean gum and combinations thereof, with the proviso that when the stabilizer is carrageenan iota, the emulsifier is not SSL.

23. The blend according to claim 222, wherein said stabilizer is a combination of alginate and/or xanthan and starch.

24. An emulsified meat product which is cold-prepared and heat stabilized by a blend according to claim 19.

25. The meat product according to claim 24, which is a sausage or a luncheon meat.
